(19) United States
(12) Patent Application Publication
(10) Pub. No.: US 2026/0235346 A1
(43) Pub. Date: Aug. 13, 2026

(54) DOOR BODY ASSEMBLY AND REFRIGERATION APPARATUS

(71) Applicants: HEFEI MIDEA REFRIGERATOR CO., LTD., Hefei (CN); HEFEI HUALING CO., LTD., Hefei (CN); MIDEA GROUP CO., LTD., Foshan (CN)

(72) Inventors: Bo Xie, Hefei (CN); Zhanwei Liu, Hefei (CN); Tianxiang Jia, Hefei (CN); Dalei Yin, Hefei (CN)

(21) Appl. No.: 19/161,245

(22) PCT Filed: Nov. 19, 2024
(86) PCT No.: PCT/CN2024/133023

§ 371 Date: Aug. 30, 2025

(30) Foreign Application Priority Data
Nov. 27, 2023 (CN) 202323218961.3
Jan. 22, 2024 (CN) 202410088590.1
Aug. 26, 2024 (CN) 202411187746.8

(51) Int. Cl. F25D 23/02; E05D 15/58

(52) U.S. Cl. CPC F25D 23/028; E05D 15/58; F25D 23/021; E05Y 2900/31

(57) ABSTRACT

The present application relates to the technical field of refrigeration apparatuses. Provided are a door body device and a refrigeration apparatus. The door body device comprises: a refrigerator door, which is adapted to rotatably connect to a refrigerator body by means of a single-axis hinge and is adapted to open or close a storage space of the refrigerator body; a cupboard door, which is a wooden cupboard door slidably arranged on an outer side of the refrigerator door; and a sliding door mechanism, which comprises a traction assembly and a sliding door assembly connected to each other, wherein the traction assembly is arranged on a front surface of the refrigerator body, the sliding door assembly is arranged on the refrigerator door and connected to the cupboard door, and the traction assembly is configured, during opening or closing of the refrigerator door, to drive the sliding door assembly to act, so as to drive the cupboard door to move in the direction of width relative to the refrigerator door. Thus, when the refrigerator door rotates relative to the refrigerator body, the sliding door assembly can be driven by the traction assembly to cause the cupboard door to move relative to the refrigerator door, such that, when the refrigeration apparatus is embedded in a cabinet, while the coordination is ensured, the cupboard door is prevented from interfering with the cabinet.

### CROSS-REFERENCES TO RELATED APPLICATIONS

The present application claims priority to Chinese patent application No. 202323218961.3 filed on Nov. 27, 2023, entitled “Refrigerator Hinge”, Chinese patent application No. 202410088590.1 filed on Jan. 22, 2024, entitled “Door Body Assembly and Refrigeration Device”, and Chinese patent application No. 202411187746.8 filed on Aug. 26, 2024, entitled “Door Body Device and Refrigeration Apparatus”, which are hereby incorporated by reference in their entireties.

### FIELD

The present application relates to the field of refrigeration apparatus, and in particular, to a door body device, and a refrigeration apparatus.

### BACKGROUND

A refrigerator is an essential appliance in almost every household. Most traditional refrigerators are upright cabinet-style. Whether it is in a kitchen, a living room, etc., placement of the refrigerator requires a certain amount of space. To save space, some traditional refrigerators are placed together with cupboards in a built-in manner.

To further enhance coordination and aesthetics, some refrigerators in the built-in manner have a decorative panel added at an outside of a refrigerator door, and it is ensured that the decorative panel is flush with a cupboard at a side of the refrigerator. However, in actual use, a gap between the refrigerator and the cupboard is small. During a process of opening the refrigerator door, the decorative panel interferes with the cupboard, which affects user experience.

### BRIEF SUMMARY

The present application provides a door device and a refrigeration apparatus, to avoid a problem of interference between a decorative panel and a cupboard during a process of opening a refrigerator door while ensuring coordination and aesthetics and not affecting user experience.

The present application further provides a refrigeration apparatus.

A door body device according to an embodiment of the present application includes:
a box door, where the box door is configured to be rotatably connected to the box body through a single-axis hinge, and is configured to open or close a storage space of the box body;
a cupboard door, where the cupboard door is a wooden cupboard door, and is slidably provided at an outside of the box door; and
a slide door mechanism, including a traction assembly and a slide door assembly connected to each other, the traction assembly being provided at a front surface of the box body, the slide door assembly being provided at the box door and connected to the cupboard door, and the traction assembly being configured to drive the slide door assembly to move during a process of opening or closing the box door, to drive the cupboard door to move in a width direction relative to the box door.

In the door body device of the embodiment of the present application, when the box door rotates relative to the box body, the slide door assembly may move the cupboard door relative to the box door under the drive of the traction assembly. As such, in case that the refrigeration apparatus is placed in the cupboard in the built-in manner, interference between the cupboard door and the cupboard may be avoided while ensuring coordination and aesthetics and not affecting the user experience.

In some embodiments, a number of the box door is plural, each of the box door corresponding to at least one of the storage space; and
each of the box door is rotatably connected to the box body through a plurality of the hinges, and the traction assembly is provided close to at least one of the hinges corresponding to each of the box door.

In some embodiments, the hinge includes a first hinge provided at a top wall of the box body, the first hinge including a first hinge plate and a first hinge shaft, a portion of the first hinge plate covering the top wall of the box body and a remaining portion of the first hinge plate protruding from the top wall toward a corresponding box door, the first hinge shaft extending downward from the portion of the first hinge plate protruding from the top wall, and a top of the corresponding box door being hinged to the first hinge shaft; the traction assembly is provided in a first mount area, the first mount area being provided close to the first hinge plate.

In some embodiments, the first mount area includes a first side edge, a second side edge, a third side edge and a fourth side edge, the first side edge and the third side edge being provided opposite to each other, the second side edge and the fourth side edge being provided opposite to each other, the first side edge being located in a plane where the first hinge plate is located, the second side edge being located in a plane where a side surface of the box body is located, a first distance, in a height direction of the box body, being provided between the third side edge and the first side edge, and a second distance, in a width direction of the box body, being provided between the fourth side edge and the second side edge.

In some embodiments, the first distance is greater than zero and less than or equal to 60 mm, and the second distance is greater than zero and less than or equal to 100 mm.

In some embodiments, the hinge includes a second hinge provided at the front surface of the box body, the second hinge including a second hinge plate, a second hinge shaft and a third hinge shaft, the second hinge plate including a mount plate and a connect plate, the mount plate being mounted at the front surface of the box body, the connect plate being connected to a side of the mount plate facing away from the front surface of the box body, the connect plate being provided at an angle to the mount plate, the connect plate being provided with a first side and a second side opposite to each other, the second hinge shaft being provided at the first side, a bottom of a corresponding box door being hinged to the second hinge shaft, the third hinge shaft being provided at the second side, and a top of the corresponding box door being hinged to the third hinge shaft; the traction assembly is provided in a second mount area, the second mount area being provided close to the mount plate.

In some embodiments, the second mount area is located above the mount plate, the second mount area including a first side edge, a second side edge, a third side edge and a fourth side edge, the first side edge and the third side edge being provided opposite to each other, the second side edge and the fourth side edge being provided opposite to each other, the first side edge being a top edge of the mount plate, the second side edge being located in a plane where a side surface of the box body is located, a third distance, in a height direction of the box body, being provided between the third side edge and the first side edge, and a fourth distance, in a width direction of the box body, being provided between the fourth side edge and the second side edge; and/or
the second mounting area is located below the mount plate, the second mount area including a first side edge, a second side edge, a third side edge, and a fourth side edge, the first side edge and the third side edge being provided opposite to each other, the second side edge and the fourth side edge being provided opposite to each other, the first side being a bottom edge of the mount plate, the second side edge being located in a plane where a side surface of the box body is located, a fifth distance, in a height direction of the box body, being provided between the third side edge and the first side edge, and a sixth distance, in the width direction of the box, being provided between the fourth side edge and the second side edge.

In some embodiments, the third distance is greater than zero and less than or equal to 60 mm, the fourth distance is greater than zero and less than or equal to 100 mm, the fifth distance is greater than zero and less than or equal to 60 mm, and the sixth distance is greater than zero and less than or equal to 100 mm.

In some embodiments, the hinge includes a third hinge provided at the front surface of the box body, the third hinge including a third hinge plate and a fourth hinge shaft, the third hinge plate including a support plate and an extension plate, the support plate being mounted at the front surface of the box body, the extension plate being connected to a side of the support plate away from the front surface of the box body, the support plate being provided at an angle to the extension plate, the fourth hinge shaft being provided at a top surface of the extension plate and extending upward, a bottom of a corresponding box door being hinged to the fourth hinge shaft; the traction assembly is provided in a third mount area, the third mount area being provided close to the third hinge plate.

In some embodiments, the third mount area is located above the support plate, the third mount area including a first side edge, a second side edge, a third side edge and a fourth side edge, the first side edge and the third side edge being provided opposite to each other, the second side edge and the fourth side edge being provided opposite to each other, the first side edge being a top edge of the support plate, the second side edge being located in a plane where a side surface of the box body is located, a seventh distance, in a height direction of the box body, being provided between the third side edge and the first side edge, and an eighth distance, in a width direction of the box body, being provided between the fourth side edge and the second side edge.

In some embodiments, the seventh distance is greater than zero and less than or equal to 60 mm, and the eighth distance is greater than zero and less than or equal to 100 mm.

In some embodiments, the traction assembly includes a traction rod, a first rotate shaft fixation base, and a second rotate shaft fixation base,
the first rotate shaft fixation base being connected to the slide door assembly, the second rotate shaft fixation base being connected to the front surface of the box body, an end of the traction rod being rotatably connected to the first rotate shaft fixation base, and another end of the traction rod being rotatably connected to the second rotate shaft fixation base,
where during a process of opening or closing the box door, the traction rod drives the slide door assembly to move, to drive the cupboard door to move in a width direction relative to the box door.

In some embodiments, the slide door assembly includes:
a first base being formed with a first guide rail at a side and a second guide rail at another side;
a first slider being slidably provided at the first guide rail, the traction assembly being connected to the first slider;
a second slider being slidably provided at the second guide rail and connected to the cupboard door; and
a transmission member having two ends respectively connected to the first slider and the second slider;
where during a process of opening or closing the box door, the traction assembly drives the first slider to move at the first guide rail, and the first slider drives, through the transmission member, the second slider to move in an opposite direction at the second guide rail.

In some embodiments, the transmission member includes:
a first gear rack being provided at the first slider;
a second gear rack being provided at the second slider; and
a gear being rotatably provided at the first base and meshing with the first gear rack and the second gear rack.

An embodiment of the present application provides a refrigeration apparatus, including:
a box body being formed with a storage space; and
a door device as described above, where a box door is rotatably connected to the box body and is configured to open or close the storage space of the box body.

In addition to the problems solved by the present application, the technical features that constitute the solutions, and the advantages brought by the solutions having these technical features described above, other technical features of the present application and the advantages brought by these technical features are further described in conjunction with the accompanying drawings.

### BRIEF DESCRIPTION OF THE DRAWINGS

To illustrate the solutions disclosed in the embodiments of the present application or the related art more clearly, the drawings used in the description of the embodiments or the related art are briefly described below. The drawings in the following description are only some embodiments of the present application, and other drawings may be obtained according to these drawings without any creative work for those skilled in the art.

FIG. 1 is a schematic structural diagram of a refrigeration apparatus, provided with a door body device, during sliding according to an embodiment of the present application;

FIG. 2 is a schematic structural diagram of a refrigeration apparatus provided with a door body device according to an embodiment of the present application;

FIG. 3 is a first partial enlarged schematic diagram of FIG. 2;

FIG. 4 is a second partial enlarged schematic diagram of FIG. 2;

FIG. 5 is a third partial enlarged schematic diagram of FIG. 2;

FIG. 6 is a schematic structural diagram of a first hinge in a door body device according to an embodiment of the present application;

FIG. 7 is a schematic structural diagram of a second hinge in a door body device according to an embodiment of the present application;

FIG. 8 is a schematic structural diagram of a third hinge in a door body device according to an embodiment of the present application;

FIG. 9 is a schematic structural diagram of a slide door mechanism in a door body device according to an embodiment of the present application;

FIG. 10 is a schematic structural diagram of the slide door mechanism in FIG. 9 from another perspective;

FIG. 11 is a schematic structural diagram of a slide door mechanism in a door body device according to another embodiment of the present application; and

FIG. 12 is a schematic structural diagram of the slide door mechanism in FIG. 11 from another perspective.

### REFERENCE SIGNS

100, box door; 110, first box door; 120, second box door; 200, cupboard door; 300, slide door mechanism; 310, traction assembly; 311, traction rod; 312, first rotate shaft fixation base; 313, second rotate shaft fixation base; 320, slide door assembly; 321, base; 322, first slider; 323, second slider; 324, connector; 3241, first connector; 3242, second connector; 325, joint plate; 326, first receive plate; 327, second receive plate; 328, transmission member; 3281, first gear rack; 3282, second gear rack; 3283, gear; 400, hinge; 410, first hinge; 411, first hinge plate; 412, first hinge shaft; 420, second hinge; 421, second hinge plate; 4211, mount plate; 4212, connect plate; 422, second hinge shaft; 423, third hinge shaft; 430, third hinge; 431, third hinge plate; 4311, support plate; 4312, extension plate; 432, fourth hinge shaft; 500, box body; 501, upper beam; 502, middle beam; 503, lower beam; 510, first cupboard body; 520, second cupboard body; A, first mount area; B, second mount area; C, third mount area.

### DETAILED DESCRIPTION

Implementations of the present application are described in further detail below in conjunction with the accompanying drawings and embodiments. The following embodiments are used to illustrate the present application, but are not intended to limit the scope of the present application.

In the description of the embodiments of the present application, it is to be noted that the orientation or positional relationships indicated by terms such as “center”, “longitudinal”, “lateral”, “upper”, “lower”, “front”, “rear”, “left”, “right”, “vertical”, “horizontal”, “top”, “bottom”, “inside”, “outside”, etc. are based on the orientation or positional relationship shown in the drawings, and are merely for the convenience of describing the embodiments of the present application and simplifying the description, rather than indicating or implying that the device or component stated must have a particular orientation, is constructed and operated in a particular orientation, and thus is not to be construed as limiting the embodiments of the present application. Moreover, the terms “first”, “second”, “third”, and the like are used for descriptive purposes only and are not to be construed as indicating or implying relative importance. In addition, in the description of the present application, unless otherwise specified, “multiple”, “multiple pieces”, and “multiple groups” mean two or more.

In the description of the present application, it should be noted that unless explicitly specified and defined otherwise, the terms “connected to” and “connected” shall be understood broadly, for example, it may be either fixedly connected or detachably connected, or can be integrated; it may be either mechanically connected, or electrically connected; it may be either directly connected, or indirectly connected through an intermediate medium. The specific meanings of the terms above in the present application can be understood by a person skilled in the art in accordance with specific conditions.

In the embodiments of this application, unless otherwise clearly stated and defined, the first feature being located “on” or “under” the second feature means that the first feature is in direct contact with the second feature or the first feature is in contact with the second feature by an intervening media. In addition, the first feature is “on”, “above” and “over” the second feature can refer to that the first feature is directly above or obliquely above the second feature, or simply refer to that the level height of the first feature is higher than that of the second feature. The first feature is “under”, “below” and “beneath” the second feature can refer to that the first feature is directly below or obliquely below the second feature, or simply refer to that the level height of the first feature is lower than that of the second feature.

In the description of this specification, description with reference to the terms “one embodiment”, “some embodiments”, “an example”, “specific example”, “some examples” and the like, refers to that specific features, structures, materials or characteristics described in combination with an embodiment or an example are included in at least one embodiment or example according to the embodiments of the present application. In this specification, schematic representations of the above terms are not necessarily directed to a same embodiment or example. Furthermore, the particular features, structures, materials or characteristics described can be combined in any suitable manner in any one or more embodiments or examples. In addition, those skilled in the art may combine the different embodiments or examples described in this specification, as well as the features of the different embodiments or examples, without conflicting each other.

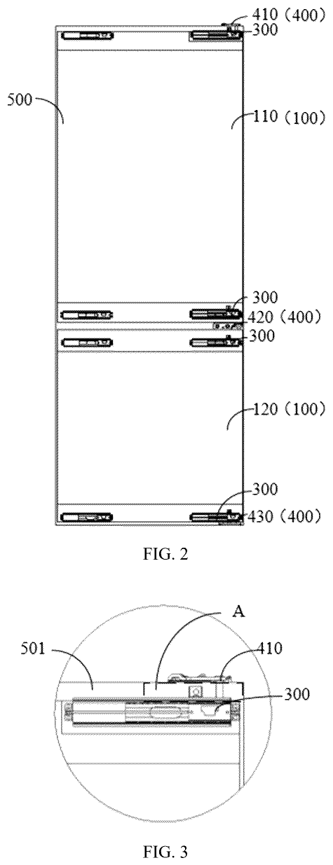

As shown in FIG. 2, an embodiment of the present application provides a door body device, including: a box door 100, a cupboard door 200, and a slide door mechanism 300. The box door 100 is configured to be rotatably connected to a box body 500 through a single-axis hinge 400, and is configured to open or close a storage space of the box body 500. The cupboard door is slidably provided at an outside of the box door. The slide door mechanism 300 includes a traction assembly 310 and a slide door assembly 320 connected to each other, the traction assembly 310 being provided at a front surface of the box body 500, the slide door assembly 320 being provided at the box door 100 and connected to the cupboard door 200, and the traction assembly 310 being configured to drive the slide door assembly 320 to move during a process of opening or closing the box door 100, to drive the cupboard door 200 to move in a width direction relative to the box door 100.

In an embodiment, a thickness of the box door 100 is 18-60 mm, for example, the thickness of the box door 100 is 18 mm, 25 mm, 50 mm, 60 mm, etc. In an embodiment, a thickness of the cupboard door 200 is 12-26 mm, for example, the thickness of the cupboard door 200 is 12 mm, 18 mm, 24 mm, 26 mm, etc. In addition, the cupboard door 200 may be a wooden door, a plastic door, etc.

The door body device in this embodiment may be used in refrigeration apparatuses such as a refrigerator, a freezer, an ice maker, etc. The refrigeration apparatus includes a box body 500, the box body 500 being formed with a storage space. The storage space may be used to store items such as vegetables, fruits, etc., that require refrigeration or freezing. In an embodiment, a refrigeration device or the like is further provided in the box body 500, where the refrigeration device may cool the storage space.

In this embodiment, the box door 100 of the door body device may be rotatably provided at the box body 500 of the refrigeration apparatus through the hinge 400. The box door 100 may be used to open or close the storage space within the box body 500. In case that the box door 100 is in a closed position to close the storage space, the storage space is in a sealed state, and items within the storage space may be cooled. In case that the box door 100 is in an open position to open the storage space, the storage space is in an open state, and a user may access items within the storage space.

To facilitate description of positional relationships between various components, in this embodiment, as shown in FIG. 2, the box body 500 is generally constructed as a rectangular parallelepiped structure having a certain height. The box body 500 may be placed at a horizontal surface. The box body 500 has a height direction, a width direction and a thickness direction which are perpendicular to each other. The height direction of the box body 500 is parallel to a vertical direction, and the width direction and the thickness direction are located within a horizontal plane and are mutually perpendicular.

The storage space is provided within the box body 500. An opening is provided at a side portion of the box body 500 in the thickness direction. The opening communicates with the storage space. The box door 100 is connected to the side portion of the box body 500 in the thickness direction provided with the opening. The box door 100 is provided extending along the width direction of the box body 500. The hinge 400 is connected to one side of the box door 100 in the width direction of the box body 500. The box door 100 may be rotatably connected to the box body 500 through the hinge 400. As such, it is ensured that the box door 100 may open or close the storage space of the box body 500.

In an embodiment, a side of the box body 500 where the box door 100 is mounted is the front surface. That is, the box door 100 is mounted at the front surface of the box body 500.

The box door 100 is generally constructed as a flat plate having a certain thickness. The box door 100 has a height direction, a width direction, and a thickness direction that are perpendicular to each other. The height direction of the box door 100 is parallel to a vertical direction, and the width direction and the length direction are located in a horizontal plane and are perpendicular to each other. One side of the box door 100 in the width direction may be rotatably connected to the box body 500 through the hinge 400. For example, as shown in FIG. 2, the box door 100 is connected to the hinge 400 at a right side of the width direction of the box body 500, and the box door 100 may be rotatably connected to the box body 500 through the hinge 400.

In an embodiment, in case that the box door 100 is in a position closing the storage space of the box body 500, the width direction of the box door 100 is parallel to the width direction of the box body 500, and the thickness direction of the box door 100 is parallel to the thickness direction of the box body 500.

In an embodiment, the cupboard door 200 may be a decorative door panel. The cupboard door 200 is constructed as a flat plate having a certain thickness. The cupboard door 200 is connected to an outside of the box door 100 facing away from the box body 500. In case that the refrigeration apparatus is placed in a built-in manner with a cupboard or directly in the cupboard, after the box door 100 is in the closed position, the cupboard door 200 may be flush with the cupboard door panel. That is, an outer wall surface of the cupboard door 200 facing away from the box door 100 may be flush with an outer wall surface of the cupboard.

In an actual use scenario, the outer wall surface of the cupboard door 200 may be made of a same material and shape as the outer wall surface of the cupboard, and may be decorated with a same decoration. As such, the refrigeration apparatus may be sufficiently coordinated with the cupboard and maintain aesthetics.

In this embodiment, after the door body device is mounted at the box body 500 of the refrigeration apparatus, in case that the box door 100 rotates relative to the box body 500 to open or close the storage space of the box body 500, the slide door mechanism 300 may drive the cupboard door 200 to move relative to the box door 100 in the width direction of the box door 100. As such, in case that the refrigeration apparatus is placed in a built-in manner in the cupboard, the cupboard door 200 may be prevented from interfering with the cupboard during a process of opening the box door 100, while ensuring coordination and aesthetics and not affecting the user experience.

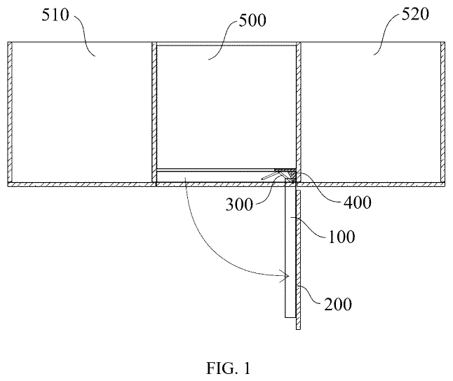

In an embodiment, as shown in FIG. 1, the door body device and the box body 500 are configured to be provided within a mount space formed between a first cupboard body 510 and a second cupboard body 520; during a process of opening or closing the box door 100, the slide door mechanism 300 is configured to drive the cupboard door 200 to move a predetermined distance at the box door 100, and the cupboard door 200 avoids sidewalls of the first cupboard body 510 and the second cupboard body 520; or
the door body device and the box body 500 are configured to be provided within a cupboard body; during a process of opening or closing the box door 100, the slide door mechanism 300 is configured to drive the cupboard door 200 to move a predetermined distance at the box door 100, and the cupboard door 200 avoids a sidewall of the cupboard body.

The refrigeration apparatus includes the door body device and the box body 500.

In practice, as shown in FIG. 1, in case that a refrigeration apparatus having the door body device and the box body 500 is placed between adjacent first cupboard body 510 and second cupboard body 520, a cupboard door 200 may be provided outside the box door 100 of the door body device. The cupboard door 200 may move relative to the box door 100 along the width direction of the box door 100. In an embodiment, in case that the box door 100 is in a state of closing the storage space of the box body 500, the outer wall surface of the cupboard door 200 facing away from the box door 100 may be flush with outer wall surfaces of the first cupboard body 510 and the second cupboard body 520. The outer wall surfaces of the first cupboard body 510 and the second cupboard body 520, and the outer wall surface of the cupboard door 200 facing away from the box door 100 are aligned in a same direction in the thickness direction of the box body 500.

In this case, during a process that the box door 100 rotates relative to the box body 500, the slide door mechanism 300 may drive the cupboard door 200 to move, allowing the cupboard door 200 to avoid the side walls of the first cupboard body 510 and the second cupboard body 520.

In an embodiment, after the refrigeration apparatus is placed in the cupboard body, the cupboard door 200 may be provided outside the box door 100 of the door body device, and the cupboard door 200 may move relative to the box door 100. In an embodiment, in case that the box door 100 is in a state of closing the storage space of the box body 500, the outer wall surface of the cupboard door 200 facing away from the box door 100 may be flush with the outer wall surface of the cupboard body, and the outer wall surface of the cupboard body and the outer wall surface of the cupboard door 200 facing away from the box door 100 are aligned in a same direction in the thickness direction of the box body 500.

In this case, during a process that the box door 100 rotates relative to the box body 500, the slide door mechanism 300 may drive the cupboard door 200 to move, and may also allow the cupboard door 200 to avoid the side wall of the cupboard body.

In an embodiment, a number of the box door 100 is plural, each of the box door 100 corresponding to at least one of the storage space, each of the box door 100 being rotatably connected to the box body 500 through a plurality of the hinges 400, and the traction assembly 310 being provided close to at least one of the hinges 400 corresponding to each of the box door 100.

Depending on different cooling requirements, the box body 500 of different refrigeration apparatuses may be provided with different numbers of storage spaces. These storage spaces are spaced apart along the height direction of the box body 500, with some storage spaces being used for refrigeration and some storage spaces being used for freezing. To enable targeted closure of these storage spaces, the number of box doors 100 may be plural, each box door 100 corresponding to at least one of the storage spaces.

For example, as shown in FIG. 2, the box body 500 is provided with two storage spaces spaced apart in the vertical direction. The two storage spaces may be used for refrigeration and freezing, respectively. The number of the box doors 100 is two, namely a first box door 110 and a second box door 120. The two box doors 110 correspond one-to-one with positions of the two storage spaces. In this case, the two storage spaces may be opened or closed separately by the two box doors 100.

For another example, the box body 500 may be provided with three storage spaces spaced apart in the vertical direction, namely, a first space, a second space, and a third space. The first space and the second space are used for refrigeration, and the third space is used for freezing. The number of the box doors 100 is two, namely a first box door 110 and a second box door 120. The first box door 110 corresponds one-to-one with positions of the first space and the second space simultaneously, and the second box door 120 corresponds to a position of the third space. In this case, the first box door 110 may open or close the first space and the second space simultaneously, and the second box door 120 may be used to independently control opening or closing state of the third space.

In this embodiment, each box door 100 may correspond to a single storage space. In this case, the opening or closing state of the storage space may be independently controlled by the box door 100. In actual use, each door 100 may also correspond to a plurality of adjacent storage spaces. In this case, the opening or closing state of the plurality of storage spaces may be controlled simultaneously by the box door 100.

In an actual application, in case that the number of the box doors 100 is plural, the plurality of box doors 100 may be spaced apart along the height direction of the box body 500. In this case, a box door 100 at a top may be rotatably connected to the box body 500 through a first hinge 410, and a box door 100 at a bottom may be rotatably connected to the box body 500 through a third hinge 430.

By providing the first hinge 410 and the third hinge 430, the box door 100 at the top and the box door 100 at the bottom may open or close their corresponding storage spaces, respectively.

To effectively mount the box door 100, the hinge 400 may further include a second hinge 420. The second hinge 420 is provided at the front surface of the box body 500 and is located between the first hinge 410 and the third hinge 430.

For example, since the plurality of box doors 100 are spaced apart along the height direction of the box body 500, the second hinge 420 may be provided between two adjacent box doors 100, and at least one of the two adjacent box doors 100 may be rotatably connected to the box body 500 through the second hinge 420.

In a practical application, a number of the second hinge 420 may be one or two. For example, in case that the number of the second hinge 420 is one, the two adjacent box doors 100 may be simultaneously connected to the second hinge 420 and simultaneously rotatably connected to the box body 500 through the second hinge 420. In case that the number of the second hinge 420 is two, the two second hinges 420 may be spaced apart along the height direction of the box body 500. In this case, the two adjacent box doors 100 may be hinged to the two second hinges 420, respectively, and then rotatably connected to the housing 500 through their respective second hinges 420.

For example, as shown in FIG. 2, in case that the door body device includes the first box door 110 and the second box door 120, the first box door 110 is rotatably connected to the box body 500 through the first hinge 410 and the second hinge 420, and the second box door 120 is rotatably connected to the box body 500 through the second hinge 420 and the third hinge 430. In this case, the traction assembly 310 is provided close to the first hinge 410 corresponding to the first box door 110, and the traction assembly 310 is located at an upper beam 501; or the traction assembly 310 is provided close to the second hinge 420 corresponding to the first box door 110, and the traction assembly 310 is located at a middle beam 502; or the traction assembly 310 is provided close to the second hinge 420 corresponding to the second box door 120, and the traction assembly 310 is located at the middle beam 502; or the traction assembly 310 is provided close to the third hinge 430 corresponding to the second box door 120, and the traction assembly 310 is located at a lower beam 503. In other words, one or two traction assemblies 310 may be provided correspondingly for the first box door 110, and one or two traction assemblies 310 may be provided correspondingly for the second box door 120.

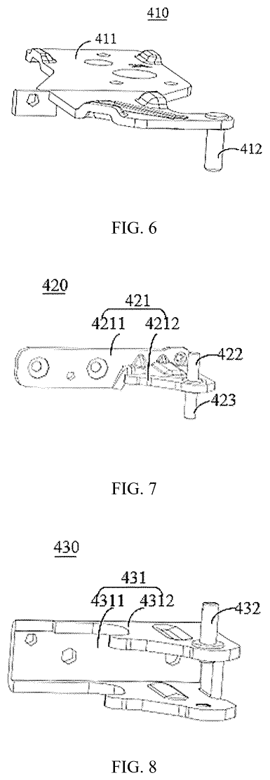

In an embodiment, as shown in FIG. 6, the first hinge 410 includes a first hinge plate 411 and a first hinge shaft 412, a portion of the first hinge plate 411 covering the top wall of the box body 500 and a remaining portion of the first hinge plate 411 protruding from the top wall toward the first box door 110, the first hinge shaft 412 extending downward from a portion of the first hinge plate 411 protruding from the top wall, a top of the first box door 110 being hinged to the first hinge shaft 412, where the traction assembly 310 is provided in a first mount area A, the first mount area A being provided close to the first hinge plate 411.

For example, the first hinge plate 411 and the first hinge shaft 412 may be made of a metal or non-metal material having a certain structural strength. The first hinge plate 411 includes a first abut portion and a first protrusion portion connected to each other. The first abut portion is provided with a plurality of mount holes. The first hinge shaft 412 is fixed to the first protrusion portion by welding or threading.

During actual mounting, a plurality of threaded holes may be pre-set at the top wall of the box body 500. The first abut portion of the first hinge plate 411 may then be abutted against the top wall of the box body 500, with the mount holes at the first abut portion aligned with the threaded holes. The first abut portion may then be fixed to the top wall of the box body 500 using bolts. The first abut portion may cover and abut against the top wall of the box body 500, the first protrusion portion may protrude from the top wall toward the box door 100, and the first hinge shaft 412 may extend downward along the height direction of the box body 500.

In an embodiment, in case of mounting the door 100, a hinge hole may be pre-set at the top of the box door 100 corresponding to the first hinge 410. The first hinge shaft 412 may then be inserted into the hinge hole, completing mounting of the box door 100.

As shown in FIG. 2, the traction assembly 310 located at the upper beam 501 of the box body 500 is provided close to the first hinge 410. Under an action of the traction assembly 310, the slide door assembly 320 may drive the cupboard door 200 corresponding to the first box door 110 to move relative to the width direction of the first box door 110.

The traction assembly 310 located at the upper beam 501 of the box body 500 is provided close to the first hinge plate 411. In addition, as shown in FIG. 3, the traction assembly 310 is provided in the first mount area A, the first mount area A includes a first side edge, a second side edge, a third side edge and a fourth side edge, the first side edge and the third side edge being provided opposite to each other, the second side edge and the fourth side edge being provided opposite to each other, the first side edge being located in a plane where the first hinge plate 411 is located, the second side edge being located in a plane where a side surface of the box body 500 is located, a first distance, in a height direction of the box body 500, being provided between the third side edge and the first side edge, and a second distance, in a width direction of the box body 500, being provided between the fourth side edge and the second side edge.

In an embodiment, the first distance is greater than zero and is less than or equal to 60 mm, and the second distance is greater than zero and is less than or equal to 100 mm. For example, the second distance is 20 mm, 40 mm, 60 mm, 80 mm, or 100 mm, and the first distance is 20 mm, 30 mm, 50 mm, or 60 mm.

In an embodiment, as shown in FIG. 7, the second hinge 420 includes a second hinge plate 421, a second hinge shaft 422 and a third hinge shaft 423, the second hinge plate 421 including a mount plate 4211 and a connect plate 4212, the mount plate 4211 being mounted at the front surface of the box body 500 (at the middle beam 502), the connect plate 4212 being connected to a side of the mount plate 4211 facing away from the front surface of the box body 500, the connect plate 4212 being provided at an angle to the mount plate 4211, the connect plate 4212 being provided with a first side and a second side opposite to each other, the second hinge shaft 422 being provided at the first side, a bottom of the first box door 110 being hinged to the second hinge shaft 422, the second hinge shaft 422 being provided at the second side, and a top of the second box door 120 being hinged to the second hinge shaft 422.

For example, the second hinge plate 421 may be made of a metal or non-metal material having a certain structural strength. The second hinge plate 421 includes a mount plate 4211 and a connect plate 4212 connected to each other. The connect plate 4212 is approximately perpendicular to the mount plate 4211 and is provided with a plurality of mount holes. During actual production, the mount plate 4211 and the connect plate 4212 may be integrally formed from a single sheet of material. Subsequently, the connect plate 4212 may be bent relative to the mount plate 4211 by stamping and folding.

The connect plate 4212 has two sides in the thickness direction, namely a first side and a second side. The first side is fixedly connected to the first hinge shaft 412, and the second side is fixedly connected to the second hinge shaft 422.

During actual production, the second hinge shaft 422 and the third hinge shaft 423 may be fixedly connected to the connect plate 4212 by welding. Alternatively, the second hinge shaft 422 and the third hinge shaft 423 may be constructed as an integrated, elongated, and rod-shaped member. The connect plate 4212 is provided with a through-hole penetrating through its thickness direction. The integrated member is inserted into the through-hole and fixed in the through-hole by welding or threading. Two ends of the integrated member in the longitudinal direction at the connect plate 4212 are respectively formed as the second hinge shaft 422 and the third hinge shaft 423.

During actual mounting, a plurality of threaded holes may be pre-set at the front surface of the box body 500 based on a mount position of the door 100. For example, as shown in FIG. 2, a plurality of threaded holes may be set at the front surface of the box body 500 at positions corresponding to a gap between the first box door 110 and the second box door 120. Mount holes at the mount plate 4211 of the first hinge plate 411 are then aligned with the threaded holes. The mount plate 4211 is then fixed to the front surface of the box body 500 using bolts. The connect plate 4212 extends toward a direction of the box door 100. The first hinge shaft 412 extends upward along the height direction of the box body 500, and the second hinge shaft 422 extends downward along the height direction of the box body 500.

In an embodiment, in case of mounting the box door 100, a hinge hole may be pre-set at the bottom of the first box door 110 corresponding to the second hinge shaft 422, and a hinge hole may be pre-set at the top of the second box door 120 corresponding to the third hinge shaft 423. The first hinge shaft 412 and the second hinge shaft 422 may then be inserted into the hinge holes of the corresponding box doors 100, completing the mounting of the box door 100.

The traction assembly 310 located at the middle beam 502 of the box body 500 is provided close to the mount plate 4211.

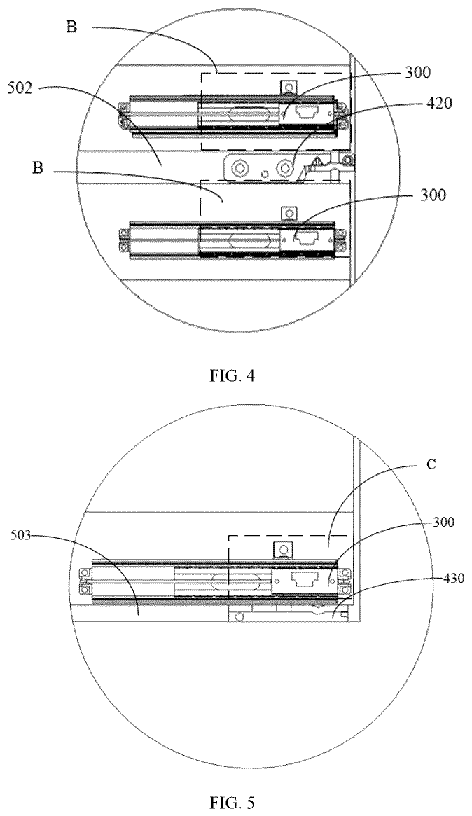

As shown in FIG. 4, in case that the second mount area B is located above the mount plate 4211, the second mount area (B) includes a first side edge, a second side edge, a third side edge and a fourth side edge, the first side edge and the third side edge being provided opposite to each other, the second side edge and the fourth side edge being provided opposite to each other, the first side edge being a top edge of the mount plate 4211, the second side edge being located in a plane where a side surface of the box body 500 is located, a third distance, in a height direction of the box body 500, being provided between the third side edge and the first side edge, and a fourth distance, in a width direction of the box body 500, being provided between the fourth side edge and the second side edge. In this case, the traction assembly 310 corresponding to the first box door 110 is located in the second mount area B.

In case that the second mounting area B is located below the mount plate 4211, the second mount area B includes a first side edge, a second side edge, a third side edge, and a fourth side edge, the first side edge and the third side edge being provided opposite to each other, the second side edge and the fourth side edge being provided opposite to each other, the first side edge being a bottom edge of the mount plate 4211, the second side edge being located in a plane where a side surface of the box body 500 is located, a fifth distance, in a height direction of the box body 500, being provided between the third side edge and the first side edge, and a sixth distance, in the width direction of the box 500, being provided between the fourth side edge and the second side edge. In this case, the traction assembly 310 corresponding to the second box door 120 is located in the second mount area B.

In an embodiment, the third distance is greater than zero and less than or equal to 60 mm, and the fourth distance is greater than zero and less than or equal to 100 mm. For example, the fourth distance is 20 mm, 40 mm, 60 mm, 80 mm, or 100 mm, and the third distance is 20 mm, 30 mm, 50 mm, or 60 mm.

In an embodiment, the fifth distance is greater than zero and less than or equal to 60 mm, and the sixth distance is greater than zero and less than or equal to 100 mm. For example, the sixth distance is 20 mm, 40 mm, 60 mm, 80 mm, or 100 mm, and the fifth distance is 20 mm, 30 mm, 50 mm, or 60 mm.

In an embodiment, as shown in FIG. 8, the third hinge 430 includes a third hinge plate 431 and a fourth hinge shaft 432, the third hinge plate 431 including a support plate 4311 and an extension plate 4312, the support plate 4311 being mounted at the front surface of the box body 500, the extension plate 4312 being connected to a side of the support plate 4311 away from the front surface of the box body 500, the support plate 4311 being provided at an angle to the extension plate 4312, the fourth hinge shaft 432 being provided at a top surface of the extension plate 4312 and extending upward, and a bottom of the second box door 120 being hinged to the fourth hinge shaft 432.

Similarly, the third hinge plate 431 may also be made of a metal or non-metal material having a certain structural strength. The second hinge plate 421 includes a support plate 4311 and an extension plate 4312 connected to each other. The extension plate 4312 is approximately perpendicular to the support plate 4311. The support plate 4311 and the extension plate 4312 may be integrally formed by stamping or other manners. The support plate 4311 is provided with a plurality of mount holes. The fourth hinge shaft 432 is fixed to the extension plate 4312 by welding or threading.

During actual mounting, a plurality of threaded holes may be pre-set at the front surface of the box body 500 near the bottom. A side of the support plate 4311 in the thickness direction may then be placed against the front surface of the box body 500. The mount holes at the support plate 4311 may then be aligned with the threaded holes. The support plate 4311 may then be fixed to the front surface of the box body 500 using bolts. The extension plate 4312 is connected to another side of the support plate 4311 in the thickness direction and extends toward a direction where the box door 100 is located. In addition, the fourth hinge shaft 432 extends upward along the height direction of the box body 500.

In an embodiment, in case of mounting the box door 100, a hinge hole may be pre-set at the bottom of the box door 100 corresponding to the second hinge 420. The fourth hinge shaft 432 may then be inserted into the hinge hole, completing mounting of the box door 100.

In an embodiment, the traction assembly 310 located at the lower beam 503 of the box body 500 is provided close to the second hinge plate 421. As shown in FIG. 5, the traction assembly 310 is provided in a third mount area C. In other words, the traction assembly 310 corresponding to the second box door 120 is provided in the third mount area C. The third mount area C includes a first side edge, a second side edge, a third side edge and a fourth side edge, the first side edge and the third side edge being provided opposite to each other, the second side edge and the fourth side edge being provided opposite to each other, the first side edge being a top edge of the support plate 4311, the second side edge being located in a plane where a side surface of the box body 500 is located, a seventh distance, in a height direction of the box body 500, being provided between the third side edge and the first side edge, and an eighth distance, in a width direction of the box body 500, being provided between the fourth side edge and the second side edge.

In an embodiment, the seventh distance is greater than zero and is less than or equal to 60 mm, and the eighth distance is greater than zero and is less than or equal to 100 mm. For example, the eighth distance is 20 mm, 40 mm, 60 mm, 80 mm, or 100 mm, and the seventh distance is 20 mm, 30 mm, 50 mm, or 60 mm.

In an embodiment, as shown in FIG. 2, a box body 500 is provided with two storage spaces spaced apart along its height direction. A first hinge 410 is provided at the top of the box body 500, a third hinge 430 is provided at the bottom of the box body 500, and a second hinge 420 is provided in the middle of the box body 500, approximately between the two storage spaces. The door body device includes two box doors 100, namely a first box door 110 and a second box door 120. The first door 110 and the second door 120 are spaced apart along the height direction of the box body 500, and the first box door 110 and the second box door 120 correspond to the two storage spaces of the box body 500, respectively. During mounting, the top of the first box door 110 is hinged to the first hinge shaft 412 of the first hinge 410, the bottom of the first box door 110 is hinged to the second hinge shaft 422 of the second hinge 420, the top of the second box door 120 is hinged to the third hinge shaft 423 of the second hinge 420, and the bottom of the second box door 120 is hinged to the fourth hinge shaft 432 of the third hinge 430. Through the above arrangement, the first box door 110 and the second box door 120 may be rotatably connected to the box body 500.

In an embodiment, to ensure that the traction assembly 310 may drive the slide door assembly 320 to move, the traction assembly 310 includes a traction rod 311, a first rotate shaft fixation base 312, and a second rotate shaft fixation base 313, the first rotate shaft fixation base 312 being connected to the slide door assembly 320, the second rotate shaft fixation base 313 being connected to the front surface of the box body 500, an end of the traction rod 311 being rotatably connected to the first rotate shaft fixation base 312, and another end of the traction rod 311 being rotatably connected to the second rotate shaft fixation base 313; during a process of opening or closing the box door 100, the traction rod 311 drives the slide door assembly 320 to move, to drive the cupboard door 200 to move in a width direction relative to the box door 100. The second rotate shaft fixation base 313 is located in the mount area (the first mount area A, the second mount area B, or the third mount area C). For example, the second rotate shaft fixation base 313 is mounted in the mount area by bolts.

For example, the hinge 400 may include a hinge plate and a hinge shaft, the hinge shaft being fixed to the hinge plate by welding or other manners. During actual mounting, the hinge plate may be fixed to the box body 500 using bolts or other structures, and the box door 100 may be provided with threaded holes in advance. After the hinge plate is fixed to the box body 500, the hinge shaft may be inserted into the hinge hole of the box door 100, achieving a rotatable connection between the box door 100 and the box body 500.

In the traction assembly 310, the first rotate shaft fixation base 312 is provided at the slide door assembly 320, and the second rotate shaft fixation base 313 is provided at the front surface and adjacent to the hinge plate. Two ends of the traction rod 311 are rotatably connected to the first rotate shaft fixation base 312 and the second rotate shaft fixation base 313, respectively.

In actual use, in case that the box door 100 rotates relative to the box body 500 between the positions of opening or closing the storage space, the traction assembly 310 may pull the slide door assembly 320 to move, enabling the slide door assembly 320 to drive the cupboard door 200 to move relative to the box door 100 in the width direction of the box door 100.

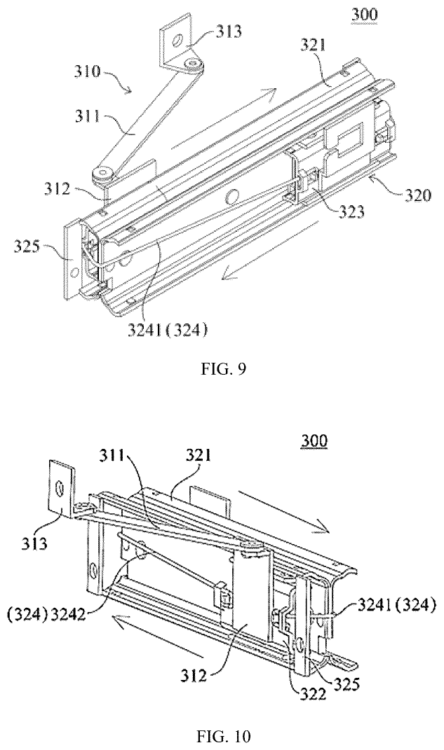

In an embodiment, to enable the slide door assembly 320 to effectively drive the cupboard door 200 to move relative to the box door 100 under the drive of the traction assembly 310, as shown in FIG. 9 and FIG. 10, the slide door assembly 320 includes: a base 321, a first slider 322, a second slider 323 and a connector 324.

The base 321 is formed with a first guide rail at a side and a second guide rail at another side; the first slider 322 is slidably provided at the first guide rail, and the first rotate shaft fixation base 312 is connected to the first slider 322; the second slider 323 is slidably provided at the second guide rail and connected to the cupboard door 200; and two ends of the connector 423 connect to the first slider 322 and the second slider 323, respectively.

During a process of opening or closing the box door 100, the traction rod 311 drives the first slider 322 to move at the first guide rail, and the first slider 322 drives, through the connector 323, the second slider 323 to move in an opposite direction at the second guide rail.

For example, the base 321 is provided with the first guide rail and the second guide rail arranged side by side and spaced apart. The first slider 322 is provided at the first guide rail and may slide along a length direction of the first guide rail. The second slider 323 is provided at the second guide rail and may slide along a length direction of the second guide rail. In addition, the first slider 322 and the second slider 323 are connected by the connector 324. In case that the first slider 322 moves at the first guide rail, the first slider 322 may pull, through the connector 324, the second slider 323 to move at the second guide rail. A movement direction of the second slider 323 is opposite to a movement direction of the first slider 322.

In an embodiment, as shown in FIG. 9 and FIG. 10, two opposite sides of the base 321 in a thickness direction are respectively a first side and a second side. U-shaped grooves are formed at the first side and the second side, respectively. A U-shaped groove at the first side is a first guide rail, and a U-shaped groove at the second side is a second guide rail. The first guide rail and the second guide rail extend along a length direction of the base 321. The first slider 322 is slidably provided in the first guide rail, and the second slider 323 is slidably provided in the second guide rail. In addition, the first rotate shaft fixation base 312 is connected to the first slider 322, and the cupboard door 200 may be fixedly connected to the second slider 323.

Taking into account practical application needs, limit structures may be provided at two ends of the first guide rail and the second guide rail. Through limitation of the limit structure, the first slider 322 and the second slider 323 may move within a set moving range, and a moving distance may be set according to demand to meet use requirements of different occasions.

In an embodiment, the traction rod 311 is constructed as a long straight rod. An end of the traction rod 311 is rotatably connected to the first rotate shaft fixation base 312 through a first rotate shaft, and another end of the traction rod 311 is rotatably connected to the second rotate shaft fixation base 313 through a second rotate shaft.

In an embodiment, as shown in FIG. 10, the first rotate shaft fixation base 312 includes a first vertical plate and a first horizontal plate. The first vertical plate and the first horizontal plate are connected to each other to form an L-shaped structure. The first horizontal plate is provided with an axis hole, in which the first rotate shaft is inserted. An end of the traction rod 311 is rotatably connected to the first rotate shaft, and is fixedly connected to the first rotate shaft fixation base 312. The first vertical plate may be fixedly connected to the first slider 322 by welding or other manners.

Similarly, as shown in FIG. 9 and FIG. 10, the second rotate shaft fixation base 313 includes a second vertical plate and a second horizontal plate. The second vertical plate and the second horizontal plate are connected to each other to form an L-shaped structure. The second horizontal plate is provided with an axis hole, in which the second rotate shaft may be inserted. Another end of the traction rod 311 is rotatably connected to the second rotate shaft, and is rotatably connected to the second rotate shaft fixation base 313.

To ensure that the first slider 322 and the second slider 323 may move synchronously in opposite directions, for example, the connector 324 includes a first connector 3241 and a second connector 3242, and the first connector 3241 and the second connector 3242 are configured as flexible ropes. Along the length direction of the base 321, the first connector 3241 passes around an end portion of the base 321, two ends of the first connector 3241 respectively entering the first guide rail and the second guide rail and connecting to the first slider 322 and the second slider 323. The second connector 3242 passes around another end portion of the base 321, two ends of the second connector 3242 respectively entering the first guide rail and the second guide rail and connecting to the first slider 322 and the second slider 323. The two ends of the first connector 3241 are connected to the two ends of the second connector 3242 through the first slider 322 and the second slider 323, forming a generally annular structure.

During actual mounting, after the hinge plate is fixedly mounted at the box body 500, the second rotate shaft fixation base 313 may be fixed to the front surface of the box body 500 using bolts or other structures.

The base 321 may then be fixed to the box door 100 using bolts or other structures. For example, two joint plates 325 are provided at two sides of the base 321 along its length direction, the two joint plates 325 are respectively provided with through-holes. During mounting, external bolts may be passed through the through-holes of the two joint plates 325 and connected to the box door 100, fixing the base 321 to the box door 100.

The cupboard door 200 is then fixed to the second slider 323. For example, bolts, a snap-fit structure, or the like may be used to allow the cupboard door 200 to be fixedly connected to the second slider 323.

In actual use, as shown in FIG. 9 and FIG. 10, in case that the box door 100 moves relative to the box body 500 from a position closing the storage space to a position opening the storage space, since the first rotate shaft fixation base 312 is fixed to the box door 100 following a hinge base, the first slider 322 moves along the first guide rail in a first direction during rotation of the box door 100. The first slider 322 pulls, through the first connector 3241, the second slider 323 along the second guide rail to move along the second direction. Since the base 321 is fixedly connected to the box door 100 and the second slider 323 is fixedly connected to the cupboard door 200, the cupboard door 200 moves relative to the box door 100 in the second direction. The first direction is opposite to the second direction, and both the first direction and the second direction are parallel to the width direction of the box door 100.

In an embodiment, in case that the box door 100 moves relative to the box body 500 from a position opening the storage space to a position closing the storage space, during the rotation of the box door 100, the first slider 322 moves at the first guide rail in a direction opposite to the first direction. The first slider 322 pulls, through the second connector 3242, the second slider 323 at the second guide rail to move in a direction opposite to the second direction. In this case, the cupboard door 200 moves relative to the box door 100 in a direction opposite to the second direction.

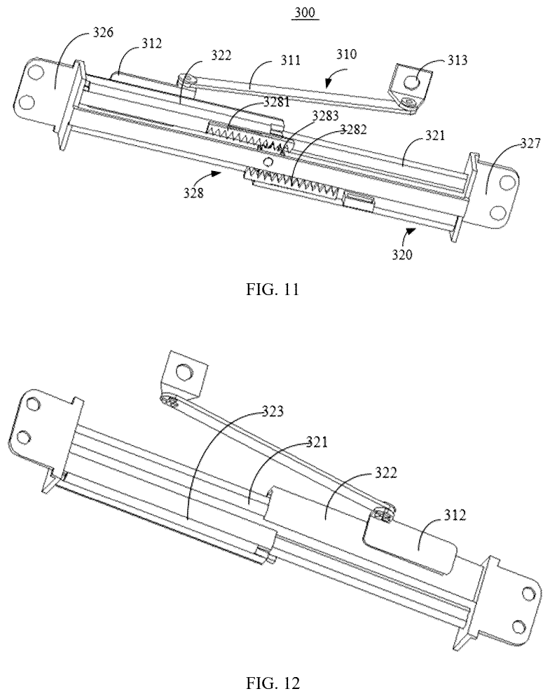

In an embodiment, as shown in FIG. 11 and FIG. 12, the slide door mechanism 300 includes a base 321, a first slider 322, a second slider 323, and a transmission member 328. The base 321 is formed with a first guide rail at a side and a second guide rail at another side. The first slider 322 is slidably provided at the first guide rail, and the second slider 323 is slidably provided at the second guide rail. The transmission member 328 has two ends that are in transmission connection with the first slider 322 and the second slider 323, respectively. In case that the first slider 322 moves at the first guide rail, the first slider 322 drives, through the transmission member 328, the second slider 323 to move in the opposite direction at the second guide rail.

The base 321 may be fixed to the box door 100 using bolts or other structures. For example, a first receive plate 326 and a second receive plate 327 are provided at two sides of the base 321 in the longitudinal direction. The first receive plate 326 and the second receive plate 327 are provided with a through hole, respectively. During mounting, external bolts may be passed through the through holes in the first receive plate 326 and the second receive plate 327 and connected to the box door 100, fixing the base 321 to the box door 100.

In some embodiments, the traction assembly includes a first connect rod and a second connect rod. A first end of the first connect rod is rotatably provided at the front surface of the box body.

The first end of the first connect rod is rotatably provided within the mount area. For example, the first end of the first connect rod is mounted within the mount area through a rotate shaft fixation base. A first end of the second connect rod is rotatably connected to a second end of the first connect rod. A second end of the second connect rod is rotatably provided at the box door 100 and is engaged with a toothed portion at the first slider 322 through a gear provided at the second end of the second connect rod.

The first connect rod and the second connect rod are connected by a hinge. The first connect rod and the second connect rod are rotatable relative to each other. The first connect rod may rotate relative to the box body 500, and the second connect rod may rotate relative to the box door 100.

In case that the second end of the second connect rod moves with the box door 100 in a circular motion with the hinge shaft as a center, a distance between the second end of the second connect rod and the first end of the first connect rod changes due to an offset arrangement of the first end of the first connect rod and the hinge shaft, while a position of the second end of the second connect rod relative to the box door 100 remains unchanged. This causes the second end of the second connect rod to rotate about the box door 100, driving the second slider 323 to move the cupboard door 200 along the width direction of the box door 100.

In actual application, during the process of opening the box door 100, the box door 100 drives the second end of the second connect rod to rotate relative to the hinge shaft. Due to the offset arrangement of the first end of the first connect rod and the hinge shaft, a distance between the first end of the first connect rod and the second end of the second connect rod increases, driving the second end of the second connect rod to rotate clockwise relative to the box door 100, and controlling the second slider 323 to drive the cupboard door 200 to move along the width direction of the box door 100 in a direction away from the hinge 400, that is, to move to the left relative to the box door 100, which may avoid interference between the cupboard door 200 and a cupboard door 200 of a side cupboard body. During the process of closing the box door 100, the box door 100 drives the second end of the second connect rod to rotate relative to the hinge shaft. Due to the offset arrangement of the first end of the first connect rod and the hinge shaft, the distance between the first end of the first connect rod and the second end of the second connect rod decreases, driving the second end of the second connect rod to rotate counterclockwise relative to the box door 100, and controlling the second slider 323 to move the cupboard door 200 along the width direction of the box door 100 toward the hinge 400, that is, to the right relative to the box door 100, which may ensure that when closing the box door 100, the cupboard door 200 may avoid a cupboard door 200 of a side cupboard body and return to its original position.

In an embodiment, the first rotate shaft fixation base 312 is connected to the first slider 322, and the second slider 323 is connected to the cupboard door 200. The first guide rail and the second guide rail are used as a kind of track, and the first slider 322 and the second slider 323 are slide members that are adapted to corresponding guide rails and may slide along the corresponding guide rails. In addition, a slide cooperation between the first slider 322 and the first guide rail should at least include a situation where a ball is set between the first slider 322 and the first guide rail, and a slide cooperation between the second slider 323 and the second guide rail should at least include a situation where a ball is set between the second slider 323 and the second guide rail.

As shown in FIG. 11, the transmission member 328 includes a first gear rack 3281, a second gear rack 3282, and a gear 3283. The first rack 3281 is provided at the first slider 322, and the second gear rack 3282 is provided at the second slider 323. The gear 3283 is rotatably provided at the base 321 and meshes with the first gear rack 3281 and the second gear rack 3282.

In this embodiment, in case that the first slider 322 slides along the first guide rail, the first gear rack 3281 slides with the first slider 322. The first gear rack 3281 meshes with the gear 3283. The first gear rack 3281, when sliding, drives the gear 3283 to rotate. The second gear rack 3282 and the first gear rack 3281 respectively meshes with the two sides of the gear 3283. The gear 3283, when rotating, drives the second gear rack 3282 to slide in an opposite direction relative to the first gear rack 3281, driving the second slider 323 to slide in an opposite direction relative to the first slider 322. This structure is simple, convenient, and practical.

As shown in FIG. 11, the transmission member 328 further includes a pin provided at the base 321, and the gear 3283 is rotatably provided at the pin.

In this embodiment, the pin is provided at the base 321 to facilitate setting of the gear 3283. The gear 3283 is rotatably provided at the pin and may rotate about the pin to transmit action between the first gear rack 3281 and the second gear rack 3282, causing the first gear rack 3281 and the second gear rack 3282 to slide in opposite directions, and allowing the first slider 322 and the second slider 323 to slide in opposite directions.

In addition, as described above, an embodiment also provides a refrigeration apparatus, which includes a box body 500 and the door body device of the above embodiments. The box body 500 is formed with a storage space. A box door 100 is rotatably connected to the box body 500 through a hinge 400, and is configured to open or close the storage space of the box body 500.

It should be noted that the terms “parallel” and “perpendicular” in the embodiments of the present application should not be strictly limited to the geometric sense. At least manufacturing and installation errors should be taken into account. For example, an error of plus or minus 10°should be within the protection scope of the embodiments of the present application. In addition, the above embodiments are only used to illustrate the solutions of the present application, rather than to limit them. Although the present application is described in detail with reference to the aforementioned embodiments, those skilled in the art should understand that they can still modify the solutions described in the aforementioned embodiments, or make equivalent substitutions for some of the features therein. However, these modifications or substitutions do not cause the essence of the corresponding solutions to deviate from the scope of the solutions of the embodiments of the present application.

1. A door body device, used for a refrigeration apparatus comprising a box body, comprising:
a box door, wherein the box door is configured to be rotatably connected to the box body through a single-axis hinge, and is configured to open or close a storage space of the box body;
a cupboard door, wherein the cupboard door is a wooden cupboard door, and is slidably provided at an outside of the box door; and
a slide door mechanism, comprising a traction assembly and a slide door assembly connected to each other, the traction assembly being provided at a front surface of the box body, the slide door assembly being provided at the box door and connected to the cupboard door, and the traction assembly being configured to drive the slide door assembly to move during a process of opening or closing the box door, to drive the cupboard door to move in a width direction relative to the box door.

2. The door body device of claim 1, wherein a number of the box door is plural, each of the box door corresponding to at least one of the storage space; and
each of the box door is rotatably connected to the box body through a plurality of the hinges, and the traction assembly is provided close to at least one of the hinges corresponding to each of the box door.

3. The door body device of claim 2, wherein the hinge comprises a first hinge provided at a top wall of the box body, the first hinge comprising a first hinge plate and a first hinge shaft, a portion of the first hinge plate covering the top wall of the box body and a remaining portion of the first hinge plate protruding from the top wall toward a corresponding box door, the first hinge shaft extending downward from the portion of the first hinge plate protruding from the top wall, and a top of the corresponding box door being hinged to the first hinge shaft; the traction assembly is provided in a first mount area (A), the first mount area (A) being provided close to the first hinge plate.

4. The door body device of claim 3, wherein the first mount area (A) comprises a first side edge, a second side edge, a third side edge and a fourth side edge, the first side edge and the third side edge being provided opposite to each other, the second side edge and the fourth side edge being provided opposite to each other, the first side edge being located in a plane where the first hinge plate is located, the second side edge being located in a plane where a side surface of the box body is located, a first distance, in a height direction of the box body, being provided between the third side edge and the first side edge, and a second distance, in a width direction of the box body, being provided between the fourth side edge and the second side edge.

5. The door body device of claim 4, wherein the first distance is greater than zero and less than or equal to 60 mm, and the second distance is greater than zero and less than or equal to 100 mm.

6. The door body device of claim 2, wherein the hinge comprises a second hinge provided at the front surface of the box body, the second hinge comprising a second hinge plate, a second hinge shaft and a third hinge shaft, the second hinge plate comprising a mount plate and a connect plate, the mount plate being mounted at the front surface of the box body, the connect plate being connected to a side of the mount plate away from the front surface of the box body, the connect plate being provided at an angle to the mount plate, the connect plate being provided with a first side and a second side opposite to each other, the second hinge shaft being provided at the first side, a bottom of a corresponding box door being hinged to the second hinge shaft, the third hinge shaft being provided at the second side, and a top of the corresponding box door being hinged to the third hinge shaft; the traction assembly is provided in a second mount area (B), the second mount area (B) being provided close to the mount plate.

7. The door body device of claim 6, wherein the second mount area (B) is located above the mount plate, the second mount area (B) comprising a first side edge, a second side edge, a third side edge and a fourth side edge, the first side edge and the third side edge being provided opposite to each other, the second side edge and the fourth side edge being provided opposite to each other, the first side edge being a top edge of the mount plate, the second side edge being located in a plane where a side surface of the box body is located, a third distance, in a height direction of the box body, being provided between the third side edge and the first side edge, and a fourth distance, in a width direction of the box body, being provided between the fourth side edge and the second side edge; and/or
the second mounting area (B) is located below the mount plate, the second mount area (B) comprising a first side edge, a second side edge, a third side edge, and a fourth side edge, the first side edge and the third side edge being provided opposite to each other, the second side edge and the fourth side edge being provided opposite to each other, the first side edge being a bottom edge of the mount plate, the second side edge being located in a plane where a side surface of the box body is located, a fifth distance, in a height direction of the box body, being provided between the third side edge and the first side edge, and a sixth distance, in the width direction of the box, being provided between the fourth side edge and the second side edge.

8. The door device of claim 7, wherein the third distance is greater than zero and less than or equal to 60 mm, the fourth distance is greater than zero and less than or equal to 100 mm, the fifth distance is greater than zero and less than or equal to 60 mm, and the sixth distance is greater than zero and less than or equal to 100 mm.

9. The door device of claim 2, wherein the hinge comprises a third hinge provided at the front surface of the box body, the third hinge comprising a third hinge plate and a fourth hinge shaft, the third hinge plate comprising a support plate and an extension plate, the support plate being mounted at the front surface of the box body, the extension plate being connected to a side of the support plate away from the front surface of the box body, the support plate being provided at an angle to the extension plate, the fourth hinge shaft being provided at a top surface of the extension plate and extending upward, a bottom of a corresponding box door being hinged to the fourth hinge shaft; the traction assembly is provided in a third mount area (C), the third mount area (C) being provided close to the third hinge plate.

10. The door device of claim 9, wherein the third mount area (C) is located above the support plate, the third mount area (C) comprising a first side edge, a second side edge, a third side edge and a fourth side edge, the first side edge and the third side edge being provided opposite to each other, the second side edge and the fourth side edge being provided opposite to each other, the first side edge being a top edge of the support plate, the second side edge being located in a plane where a side surface of the box body is located, a seventh distance, in a height direction of the box body, being provided between the third side edge and the first side edge, and an eighth distance, in a width direction of the box body, being provided between the fourth side edge and the second side edge.

11. The door device of claim 10, wherein the seventh distance is greater than zero and less than or equal to 60 mm, and the eighth distance is greater than zero and less than or equal to 100 mm.

12. The door device of claim 1, wherein the traction assembly comprises a traction rod, a first rotate shaft fixation base, and a second rotate shaft fixation base,
the first rotate shaft fixation base being connected to the slide door assembly, the second rotate shaft fixation base being connected to the front surface of the box body, an end of the traction rod being rotatably connected to the first rotate shaft fixation base, and another end of the traction rod being rotatably connected to the second rotate shaft fixation base,
wherein during a process of opening or closing the box door, the traction rod drives the slide door assembly to move, to drive the cupboard door to move in a width direction relative to the box door.

13. The door device of claim 1, wherein the slide door assembly comprises:
a first base being formed with a first guide rail at a side and a second guide rail at another side;
a first slider being slidably provided at the first guide rail, the traction assembly being connected to the first slider;
a second slider being slidably provided at the second guide rail and connected to the cupboard door; and
a transmission member having two ends respectively connected to the first slider and the second slider;
wherein during a process of opening or closing the box door, the traction assembly drives the first slider to move at the first guide rail, and the first slider drives, through the transmission member, the second slider to move in an opposite direction at the second guide rail.

14. The door device of claim 13, wherein the transmission member comprises:
a first gear rack being provided at the first slider;
a second gear rack being provided at the second slider; and
a gear being rotatably provided at the first base and meshing with the first gear rack and the second gear rack.

15. A refrigeration apparatus, comprising:
a box body being formed with a storage space; and
the door device of claim 1, wherein the box door is rotatably connected to the box body and is configured to open or close the storage space of the box body.
